(19) United States
(12) Patent Application Publication
(10) Pub. No.: US 2026/0110952 A1
(43) Pub. Date: Apr. 23, 2026

(54) PET SMART CAMERA

(71) Applicant: VERITI PTE. LTD., Singapore (SG)

(72) Inventor: Huaiyu ZHU, Singapore (SG)

(73) Assignee: VERITI PTE. LTD., Singapore (SG)

(21) Appl. No.: 18/968,151

(22) Filed: Dec. 4, 2024

(30) Foreign Application Priority Data
Oct. 23, 2024 (CN) 202422569874.0

(51) Int. Cl. G03B 17/56; F16M 11/04; F16M 11/10; F16M 13/02; G03B 17/18; H04N 23/11

(52) U.S. Cl. CPC G03B 17/561; F16M 11/041; F16M 11/10; F16M 13/02; G03B 17/18; H04N 23/11

(57) ABSTRACT

Disclosed is a pet smart camera, including a camera body, a first bracket and a wall-mounting bracket. The first bracket is rotatably connected to the camera body. A first quick-release structure is provided at one end of the first bracket away from the camera body. The wall-mounting bracket is fixed on a wall. A second quick-release structure is provided on a side of the wall-mounting bracket facing away from the wall, and the first quick-release structure is connected to the second quick-release structure to fix the camera body and the first bracket on the wall.

### CROSS-REFERENCE TO RELATED APPLICATIONS

This application claims priority to Chinese Patent Application No. 202422569874.0, filed on Oct. 23, 2024, the entire contents of which are incorporated herein by reference.

### TECHNICAL FIELD

The present application relates to the technical field of smart home products, and in particular to a pet smart camera.

### BACKGROUND

In the related art, when designing a pet smart camera, the importance of mounting components is often overlooked. Traditionally, cameras are usually designed to be placed on a flat surface without any corresponding mounting structures. This design results in the camera's usage scenarios being greatly restricted during use. Users cannot fix the camera on walls, ceilings, or other high locations, which limits the range of photography and makes it impossible to fully capture the activities of pets, especially when pets are active at different heights. The traditional method is difficult to meet user needs.

### SUMMARY

The main purpose of the present application is to provide a pet smart camera, aiming to allow the pet smart camera to be used in different scenarios to meet the different usage needs of users.

To achieve the above purpose, the present application provides a pet smart camera, including: a camera body, a first bracket and a wall-mounting bracket. The first bracket is rotatably connected to the camera body, and a first quick-release structure is provided at one end of the first bracket away from the camera body. The wall-mounting bracket is fixed on a wall. A second quick-release structure is provided on a side of the wall-mounting bracket facing away from the wall, and the first quick-release structure is connected to the second quick-release structure to fix the camera body and the first bracket on the wall.

In an embodiment, the first quick-release structure includes at least two clamping positions, and the at least two clamping positions are spaced apart; the second quick-release structure includes at least two clamping protrusions, and the at least two clamping protrusions are spaced apart; each clamping protrusion is clamped into one of the clamping positions, and the wall-mounting bracket is detachably connected with the first bracket.

In an embodiment, each of the clamping protrusions is provided with an embedding hole; a side of the first bracket facing the wall-mounting bracket is provided with a counterbore, a guide hole and a retaining rib opposite to a bottom wall of the counterbore; the counterbore is communicated with the guide hole to form the clamping position; the clamping protrusion is configured to slide into the counterbore along the guide hole, enabling the retaining rib to be clamped into the embedding hole.

In an embodiment, a limiting convex point is provided on a side of the clamping protrusion facing the first bracket; a limiting groove is provided at the bottom wall of the counterbore, and when the limiting convex point is clamped into the limiting groove, the retaining rib is clamped into the embedding hole.

In an embodiment, the first bracket includes a frame, a base, a fixed block, and at least one connecting member; one end of the frame is rotatably connected to the camera body, and the other end of the frame is rotatably connected to the base; the base is provided with a mounting hole and the first quick-release structure, and the mounting hole is configured to pass through the base and is spaced apart from the first quick-release structure; the fixed block is provided on a side of the base facing away from the frame; the connecting member is configured to pass through the fixed block and the mounting hole, and the connecting member is connected to the frame.

In an embodiment, the base is further provided with a turntable, and the turntable is provided with a mounting groove; the mounting groove is communicated with the mounting hole and is coaxially with the mounting hole; the mounting groove is provided at the side of the base facing away from the frame, and the fixed block is provided in the mounting groove.

In an embodiment, an annular groove is provided on one side of the frame facing the turntable; the first bracket further includes an elastic ring, and the elastic ring is provided in the annular groove and elastically abutted against the turntable.

In an embodiment, the pet smart camera further includes a rotating shaft and an elastic member. An end of the first bracket away from the first quick-release structure is provided with a rotation groove and a notch communicated with the rotation groove; an outer wall of the camera body is provided with an assembly protrusion, and the assembly protrusion is provided at the notch; the rotating shaft is inserted into the rotation groove and is configured to pass through the assembly protrusion; one end of the elastic member is abutted against the rotating shaft, and the other end of the elastic member is abutted against the assembly protrusion, enabling the camera body to rotate relative to the first bracket.

In an embodiment, the pet smart camera further includes a placement rack. The placement rack is provided with a fixed groove; a groove wall of the fixed groove is provided with a plurality of elastic plugs, and the plurality of elastic plugs are provided in an array; the camera body is provided at the fixed groove and elastically abutted against the plurality of elastic plugs.

In an embodiment, the placement rack is arched.

In an embodiment, a shape of the fixed groove is adapted to a contour shape of the camera body.

In an embodiment, the pet smart camera further includes a cover. The camera body includes a housing and a lens provided in the housing; the housing includes an assembly port, and the lens is provided at the assembly port; at least one first magnetic member is provided in the housing, and the first magnetic member is staggered with the lens; the cover is provided with at least one second magnetic member, and the second magnetic member is attracted and combined with the first magnetic member, enabling the cover to be covered on the assembly port and to block the lens.

In an embodiment, the cover is further provided with a third magnetic member, and the third magnetic member is provided at a center of the cover, and is spaced apart from the second magnetic member; and the third magnetic member is attracted and combined with the first magnetic member, enabling the cover to be staggered with the assembly port.

In an embodiment, the camera body further includes a main circuit board, at least two function indicator lights and at least one light guide column; the main circuit board is provided in the housing; the lens and the at least two function indicator lights are provided at the main circuit board and are electrically connected to the main circuit board; the light guide column is provided in front of the at least two function indicator lights and is configured to transmit the light of the at least two function indicator lights to an outside world.

In an embodiment, the camera body further includes a plurality of night vision infrared lights; the plurality of night vision infrared lights are provided at the main circuit board and are electrically connected to the main circuit board, and the plurality of night vision infrared lights are provided around the lens.

In technical solutions of the present application, the pet smart camera includes a camera body, a first bracket and a wall-mounting bracket. The first bracket is rotatably connected to the camera body. A first quick-release structure is provided at one end of the first bracket away from the camera body. The wall-mounting bracket is fixed on the wall, and a second quick-release structure is provided on the side of the wall-mounting bracket facing away from the wall. The first quick-release structure is connected to the quick-release structure to fix the camera body and the first bracket on the wall. Through the connection between the first quick-release structure and the second quick-release structure, the camera body and the first bracket can be firmly fixed on the wall, making the connection between the camera body and the first bracket, and the first bracket and the wall-mounting bracket more convenient, so that the pet smart camera can not only be fixed on the wall for use, but also placed on the desktop for use, so that the pet smart camera can be used in different scenes, thereby meeting the different usage needs of users.

### BRIEF DESCRIPTION OF THE DRAWINGS

In order to more clearly illustrate the embodiments of the present application or the technical solutions in the related art, the drawings required for use in the embodiments or the description of the related art will be briefly introduced below. Obviously, the drawings described below are only some embodiments of the present application. For those skilled in the art other drawings can be obtained based on the structures shown in these drawings without creative work.

FIG. 1 is a three-dimensional view of a pet smart camera.

FIG. 2 is an exploded view of a first bracket and a wall-mounting bracket of the pet smart camera from one perspective.

FIG. 3 is an exploded view of the first bracket and the wall-mounting bracket of the pet smart camera from another perspective.

FIG. 4 is a three-dimensional view of the wall-mounting bracket of the pet smart camera.

FIG. 5 is a three-dimensional view of a base of the first bracket of the pet smart camera.

FIG. 6 is an exploded view of the first bracket of the pet smart camera.

FIG. 7 is a schematic structural view of the pet smart camera after removing part of a housing from one perspective.

FIG. 8 is a schematic structural view of the pet smart camera after removing part of the housing from another perspective.

FIG. 9 is a schematic structural view of the pet smart camera after removing part of a cover.

FIG. 10 is a three-dimensional view of the pet smart camera from another perspective.

FIG. 11 is a three-dimensional view of a placement rack of the pet smart camera.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by those skilled in the art based on the embodiments of the present application without creative efforts shall fall within the scope of the present application.

It should be noted that if there is a directional indication (such as up, down, left, right, front, rear) in the embodiments of the present application, the directional indication is only configured to explain the relative positional relationship, movement, etc. of the components in a certain posture (as shown in the drawings). If the specific posture changes, the directional indication will change accordingly.

Besides, the descriptions associated with, e.g., “first” and “second” in the present application are merely for descriptive purposes, and cannot be understood as indicating or suggesting relative importance or impliedly indicating the number of the indicated technical feature. Therefore, the feature associated with “first” or “second” can expressly or impliedly include at least one such feature. The meaning of “and/or” appearing in the present application includes three parallel scenarios. For example, “A and/or B” includes only A, or only B, or both A and B. In addition, the technical solutions between the various embodiments can be combined with each other, but they must be based on the realization of those skilled in the art. When the combination of technical solutions is contradictory or cannot be achieved, it should be considered that such a combination of technical solutions does not exist, nor is it within the scope of the present application.

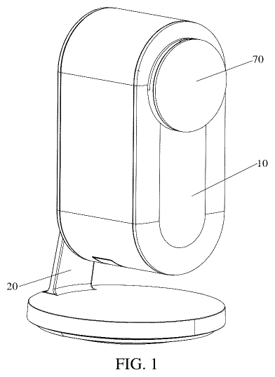

The present application provides a pet smart camera, as shown in FIG. 1 to FIG. 3, in an embodiment, the pet smart camera includes a camera body 10, a first bracket 20, and a wall-mounting bracket 30. The first bracket 20 is rotatably connected to the camera body 10. One end of the first bracket 20 away from the camera body 10 is provided with a first quick-release structure 21. The wall-mounting bracket 30 is fixed on the wall, and a second quick-release structure 31 is provided on the side of the wall-mounting bracket 30 facing away from the wall. The first quick-release structure 21 is connected to the second quick-release structure 31, so that the camera body 10 and the first bracket 20 are fixed on the wall.

The pet smart camera includes a camera body 10, a first bracket 20, and a wall-mounting bracket 30. The camera body 10 has functions such as shooting, video recording, and remote monitoring. The camera body 10 includes an image processor, a wireless communication module, a power supply module, etc. The first bracket 20 is rotatably connected to the camera body 10, enabling the camera body 10 to rotate at a certain angle relative to the first bracket 20, thereby adjusting the shooting direction.

One end of the first bracket 20 is connected to the camera body 10, and the other end of the first bracket 20 extends out. The first quick-release structure 21 is provided on the first bracket 20. The design of the first quick-release structure 21 allows it to be quickly and stably connected to the second quick-release structure 31 on the wall-mounting bracket 30.

The wall-mounting bracket 30 is fixed on the wall, and the second quick-release structure 31 is provided on the side of the wall-mounting bracket 30 facing away from the wall. The second quick-release structure 31 matches the first quick-release structure 21 and can be tightly connected to it, ensuring the camera body 10 and the first bracket 20 can be stably fixed on the wall.

When it is necessary to install the pet smart camera on the wall, first, the wall-mounting bracket 30 is fixed on the predetermined wall surface to ensure it is firm and reliable. Subsequently, the first quick-release structure 21 on the first bracket 20 is connected with the second quick-release structure 31 on the back of the wall-mounting bracket 30, and the installation can be completed through simple operations. This design makes the installation process simple and fast, and is also convenient for future maintenance and disassembly.

During the operation process, the user can remotely control the shooting direction and angle of the camera body 10 through the wireless communication module, thereby achieving all-round monitoring of pets. In addition, the image processor built in the camera body 10 can perform real-time processing on the captured images, including but not limited to image compression and image recognition, providing users with a more intelligent monitoring experience.

Compared with the traditional camera installation method, the present application can firmly fix the camera body 10 and the first bracket 20 on the wall through the connection of the first quick-release structure 21 and the second quick-release structure 31, so that the connection between the camera body 10 and the first bracket 20, and the first bracket 20 and the wall-mounting bracket 30 is more convenient. The pet smart camera can not only be fixed on the wall for use, but also placed on the desktop for use, so that the pet smart camera can be used in different scenes to meet the different usage needs of users.

At the same time, users can quickly complete the installation without using complex tools, which greatly saves installation time and labor costs. The first bracket 20 is rotatably connected to the camera body 10, enabling the camera body 10 to rotate 360 degrees. Users can adjust the shooting angle of the camera as needed to achieve all-round monitoring, thereby better meeting the monitoring needs in different scenes.

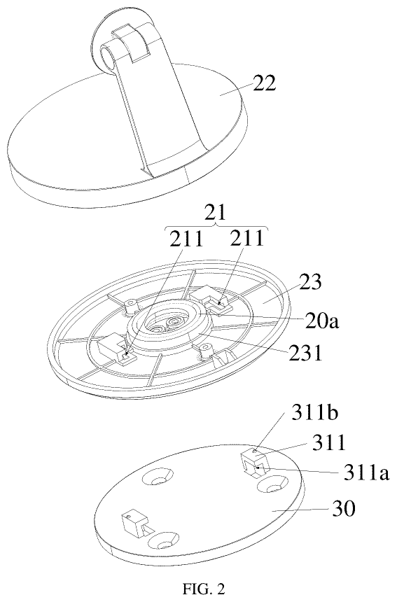

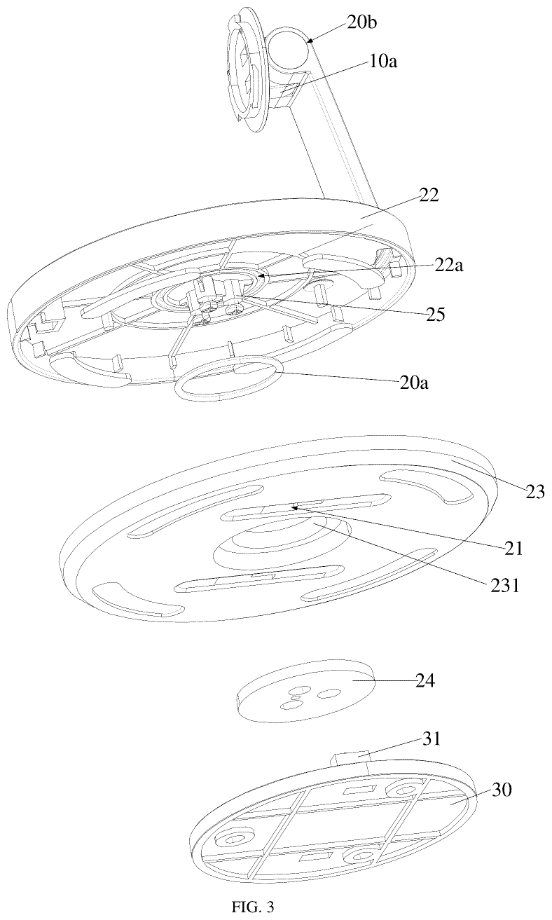

In an embodiment, as shown in FIG. 2 and FIG. 3, the first quick-release structure 21 includes at least two clamping positions 211, and the at least two clamping positions 211 are spaced apart. The second quick-release structure 31 includes at least two clamping protrusions 311, and the at least two clamping protrusions 311 are spaced apart. Each clamping protrusion 311 is clamped into a clamping position 211, so that the wall-mounting bracket 30 is detachably connected with the first bracket 20.

The clamping protrusions 311 are made of high-strength metal material with good wear resistance and toughness to ensure the stability and durability of the connection. A clamping groove is provided at the top of each clamping protrusion 311 for matching with the clamping position 211 of the first quick-release structure 21.

The at least two clamping positions 211 are spaced apart, corresponding to the clamping protrusions 311 of the second quick-release structure 31. The clamping positions 211 are also made of high-strength metal material, and its internal shape matches the clamping groove of the clamping protrusion 311 to ensure the accuracy and firmness of the clamping.

When the wall-mounting bracket 30 needs to be connected to the first bracket 20, the operator aligns the clamping protrusion 311 of the wall-mounting bracket 30 with the clamping position 211 of the first bracket 20 and applies appropriate pressure to make the clamping protrusion 311 clamped into the clamping position 211. At this time, the clamping protrusion 311 is detachably connected to the clamping position 211. If disassembly is required, the operator only needs to apply pressure in the reverse direction to make the clamping protrusion 311 disengage from the clamping position 211.

The design of the quick-release structure makes the connection process between the wall-mounting bracket 30 and the first bracket 20 simpler and faster. Each clamping protrusion 311 is correspondingly clamped with the clamping position 211, ensuring the stability of the connection, greatly reducing the installation time, and improving the work efficiency. When the wall-mounting bracket 30 or the first bracket 20 needs to be maintained or replaced, the design of the quick-release structure makes the disassembly process more convenient, saving a lot of time and labor costs, and reducing the difficulty of maintenance.

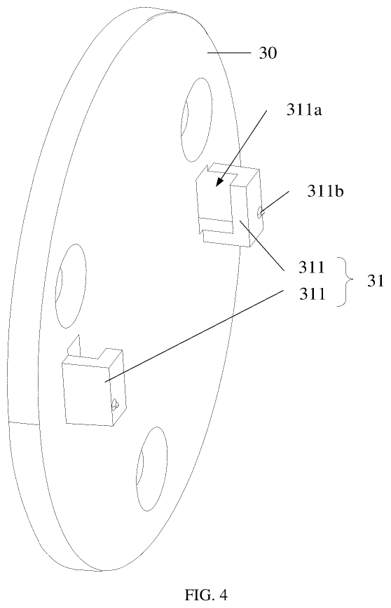

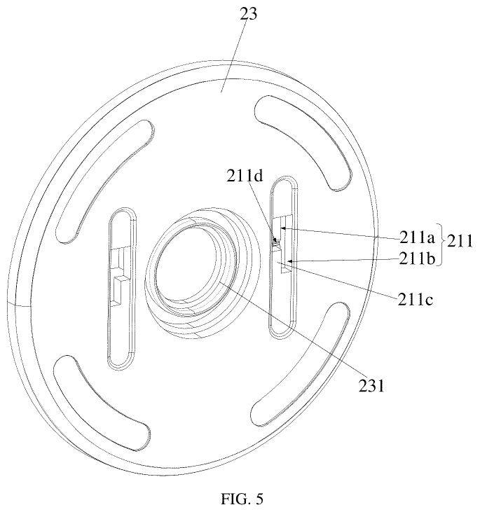

In an embodiment, as shown in FIG. 2 to FIG. 5, each clamping protrusion 311 has an embedding hole 311a. A side of the first bracket 20 facing the wall-mounting bracket 30 is provided with a counterbore 211a, a guide hole 211b and a retaining rib 211c opposite to the bottom wall of the counterbore 211a. The counterbore 211a is communicated with the guide hole 211b to form a clamping position 211. The clamping protrusion 311 slides into the counterbore 211a along the guide hole 211b so that the retaining rib 211c is clamped into the embedding hole 311a.

The side of the first bracket 20 facing the wall-mounting bracket 30 is turned toward the operator to ensure that the operator can clearly know the position and direction of the counterbore 211a, the guide hole 211b and the retaining rib 211c. The clamping protrusion 311 with the embedding hole 311a is slid into the counterbore 211a along the guide hole 211b. The operator needs to align the clamping protrusion 311 with the guide hole 211b, and then gently push the clamping protrusion 311 along the direction of the guide hole 211b to enter the counterbore 211a. When the clamping protrusion 311 completely enters the counterbore 211a, the retaining rib 211c will be inserted into the embedding hole 311a, thereby achieving a tight connection between the first bracket 20 and the clamping protrusion 311.

The design of the present application ingeniously adopts the connection mode of the clamping protrusion 311 and the embedding hole 311a. This structural design makes the connection between the first bracket 20 and the wall-mounted frame 30 more firm and reliable. Each clamping protrusion 311 has an embedding hole 311a, which can provide more contact points during the clamping process, thereby effectively dispersing the pressure of the connection part, avoiding structural damage caused by excessive concentrated force. Compared with the related art, this design greatly improves the stability and load-bearing capacity of the connection between the first bracket 20 and the wall-mounting bracket 30.

The side of the first bracket 20 facing the wall-mounting bracket 30 is provided with a counterbore 211a, a guide hole 211b and a retaining rib 211c opposite to the bottom wall of the counterbore 211a. The counterbore 211a is communicated with the guide hole 211b to form a clamping position 211. This structural design not only improves the connection accuracy, but also simplifies the installation process. In practical applications, the clamping protrusion 311 can slide into the counterbore 211a along the guide hole 211b, and this process is natural and smooth, without the need for additional auxiliary tools or complicated operating steps. This not only reduces the difficulty of installation, but also greatly improves the installation efficiency.

In addition, the design of the retaining rib 211c being inserted into the embedding hole 311a further enhances the connection strength between the first bracket 20 and the wall-mounting bracket 30. The provision of the retaining rib 211c can effectively prevent the first bracket 20 from moving laterally on the wall-mounting bracket 30, thereby ensuring the stability of the overall structure. This design not only improves the structural stability, but also extends the service life of the first bracket 20.

In an embodiment, as shown in FIG. 2 to FIG. 4, a limiting convex point 311b is provided on the side of the clamping protrusion 311 facing the first bracket 20. A limiting groove 211d is provided on the bottom wall of the counterbore 211a, and when the limiting convex point 311b is clamped into the limiting groove 211d, the retaining rib 211c is clamped into the embedding hole 311a.

A limiting convex point 311b is provided on one side of the wall-mounting bracket 30, and the limiting convex point 311b protrudes from the surface of the wall-mounting bracket 30. A limiting groove 211d is provided on the bottom wall of the counterbore 211a, and the limiting groove 211d is configured to accommodate the limiting convex point 311b of the wall-mounting bracket 30. The extending direction of the limiting groove 211d is consistent with the direction in which the clamping protrusion 311 slides into the counterbore 211a.

When the wall-mounting bracket 30 and the first bracket 20 need to be connected, the counterbore 211a of the first bracket 20 is aligned with the limiting convex point 311b of the wall-mounting bracket 30, so that the limiting convex point 311b is clamped into the limiting groove 211d. At this time, the retaining rib 211c is inserted into the embedding hole 311a of the wall-mounting bracket 30, so that the wall-mounting bracket 30 and the first bracket 20 are tightly connected. After the connection is completed, the relative position between the wall-mounting bracket 30 and the first bracket 20 is limited, preventing relative sliding between the components and improving the stability of the connection structure.

When the limiting convex point 311b is clamped into the limiting groove 211d, the movement of the wall-mounting bracket 30 can be effectively limited to ensure the accuracy of its fixed position. This design not only improves the overall stability of the wall-mounting bracket 30, but also greatly reduces the difficulty of installation, thereby saving installation time, and improving work efficiency.

When the limiting convex point 311b is clamped into the limiting groove 211d, the retaining rib 211c can be smoothly clamped into the embedded hole 311a, forming a double locking mechanism, so that the wall-mounting bracket 30 can still maintain structural stability when subjected to external forces, effectively preventing the wall-mounting bracket 30 from being offset due to vibration or external forces.

In an embodiment, as shown in FIG. 2 and FIG. 3, the first bracket 20 includes a frame 22, a base 23, a fixed block 24 and at least one connecting member 25. One end of the frame 22 is rotatably connected to the camera body 10, and the other end of the frame 22 is rotatably connected to the base 23. The base 23 is provided with a mounting hole and the first quick-release structure 21. The mounting hole passes through the base 23 and is spaced apart from the first quick-release structure 21. The fixed block 24 is provided on the side of the base 23 facing away from the frame 22. The connecting member 25 is configured to pass through the fixed block 24 and the mounting hole, and the connecting member 25 is connected to the frame 22. And/or, the base 23 is provided with a turntable 231, and the turntable 231 is provided with a mounting groove. The mounting groove is communicated with the mounting hole, and the mounting groove is coaxially with the mounting hole. The mounting groove is provided at the side of the base 23 facing away from the frame 22, and the fixed block 24 is provided in the mounting groove.

During operation, when the angle of the camera body 10 needs to be adjusted, the operator can rotate the camera body 10 by rotating the connecting part between the frame 22 and the camera body 10. At the same time, by adjusting the rotation connection between the base 23 and the frame 22, the overall position and angle of the first bracket 20 can be changed, and the shooting range of the pet smart camera can be increased. The setting of the fixed block 24 and the connecting member 25 ensures the stability and safety of the first bracket 20 during the adjustment process.

The base 23 is rotatably connected to the end of the frame 22 facing away from the camera body 10. This design allows the first bracket 20 to be flexibly adjusted to adapt to different shooting environments and angle requirements. The base 23 is provided with a mounting hole, and the mounting hole passes through the base 23. This design not only facilitates the installation of the first bracket 20, but also further improves the stability of the first bracket 20.

The turntable 231 is fixed on the base 23 and connected to the base 23 through the rotating shaft 40, and is flexible to rotate. The turntable 231 is made of stainless steel, and the surface of the turntable 231 is rust-proofed to ensure that it will not rust after long-term use. The mounting hole is provided at the center of the turntable 231 and is communicated with the mounting groove. The mounting hole facilitates cooperation with the fixed block 24. The mounting groove is coaxially with the mounting hole and is located at one side of the turntable 231. The mounting groove is configured to install the fixed block 24. The fixed block 24 is provided in the mounting groove. In this way, when the base 23 rotates relative to the frame 22, the fixed block 24 is not easily displaced, ensuring the frame 22 to rotate normally relative to the base 23.

The coaxial setting of the mounting groove and the mounting hole ensures the alignment of the fixed block 24 during the installation process, avoiding installation problems caused by offset or misalignment. At the same time, the mounting groove is provided on the side of the base 23 facing away from the frame 22. This design optimizes the spatial layout and makes the overall structure more compact.

In an embodiment, as shown in FIG. 2 and FIG. 3, the frame 22 is provided with an annular groove 22a on one side facing the turntable 231. The first bracket 20 also includes an elastic ring 20a, and the elastic ring 20a is installed in the annular groove 22a and elastically abutted against the turntable 231.

The annular groove 22a is provided at the edge of the frame 22. The shape of the annular groove 22a is annular, and its cross section is U-shaped, which is convenient for the installation and fixation of the elastic ring 20a. The frame 22 is made of high-strength material and has high stability and bearing capacity. The shape of the frame 22 can be designed according to actual application requirements, such as rectangular, circular, etc. The diameter D1 of the annular groove 22a matches the outer diameter of the turntable 231 to ensure that the elastic ring 20a can be in close contact with the turntable 231 after installation. The depth H1 of the annular groove 22a is sufficient to accommodate the elastic ring 20a, so that the elastic ring 20a will not fall off after installation. The width W1 of the annular groove 22a is appropriate, which is convenient for installing the elastic ring 20a and will not affect the overall strength of the frame 22. In addition, the first bracket 20 also includes an elastic ring 20a. The elastic ring 20a is installed in the annular groove 22a and elastically abutted against the turntable 231. When the turntable 231 rotates, the elastic abutment between the elastic ring 20a and the turntable 231 can effectively alleviate the impact force, reduce noise, and increase the service life of the turntable 231. At the same time, the installation position and structure of the elastic ring 20a make the first bracket 20 have high stability and reliability.

The elastic abutment between the elastic ring 20a and the turntable 231 enhances the connection stability between the frame 22 and the turntable 231, and avoids the loosening or falling off of the connection part caused by external force. This is of great significance for mechanical equipment that requires long-term stable operation. The elastic ring 20a allows the base 23 to generate a rotational motion with damping characteristics, ensuring that the base 23 is more stable and not loose when rotating relative to the frame 22.

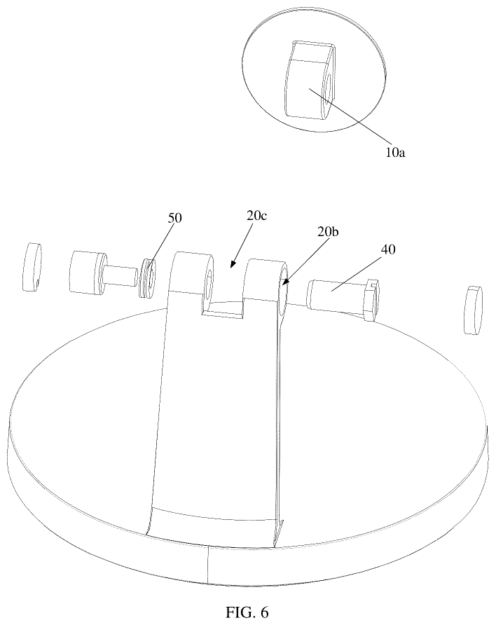

In an embodiment, as shown in FIG. 2, FIG. 3 and FIG. 6, the end of the first bracket 20 away from the first quick-release structure 21 is provided with a rotation groove 20b and a notch 20c communicated with the rotation groove 20b. The outer wall of the camera body 10 is provided with an assembly protrusion 10a, and the assembly protrusion 10a is provided at the notch 20c. The pet smart camera also includes a rotating shaft 40 and an elastic member 50. The rotating shaft 40 is inserted into the rotation groove 20b and passes through the assembly protrusion 10a. One end of the elastic member 50 is abutted against the rotating shaft 40, and the other end of the elastic member 50 is abutted against the assembly protrusion 10a, so that the camera body 10 can rotate relative to the first bracket 20.

The end of the first bracket 20 away from the first quick-release structure 21 is provided with a rotation groove 20b, and the shape of the rotation groove 20b is circular or elliptical, and its size matches the outer diameter of the rotating shaft 40. In addition, the end of the first bracket 20 away from the first quick-release structure 21 is also provided with a notch 20c communicated with the rotation groove 20b. The shape and size of the notch 20c are adapted to the assembly protrusion 10a of the camera body 10. The shape of the assembly protrusion 10a is cylindrical or the like, and its size matches the notch 20c so that it can be smoothly inserted into the notch 20c. The rotating shaft 40 is inserted into the rotation groove 20b. One end of the rotating shaft 40 is connected to the first bracket 20, and the other end of the rotating shaft 40 is connected to the camera body 10. The outer diameter of the rotating shaft 40 matches the inner diameter of the rotation groove 20b to ensure that the rotating shaft 40 can rotate freely in the rotation groove 20b. One end of the elastic member 50 is abutted against the rotating shaft 40, and the other end of the elastic member 50 is abutted against the assembly protrusion 10a. The elastic member 50 is configured to provide a certain elastic connection between the camera body 10 and the first bracket 20, so that the camera body 10 can rotate relative to the first bracket 20. The elastic member 50 can be made of metal. By utilizing the elastic properties of the metal, it is tightly connected to the rotating shaft 40 in an interference fit manner and achieves rotation, thereby ensuring that the elastic member 50 can still rotate stably in a high temperature environment.

When the user needs to install the camera, the assembly protrusion 10a of the camera body 10 is first aligned with the notch 20c of the first bracket 20, and then the assembly protrusion 10a is inserted into the notch 20c. Subsequently, the rotating shaft 40 is passed through the rotation groove 20b, so that one end of the rotating shaft 40 is connected to the first bracket 20 and the other end of the rotating shaft 40 is connected to the camera body 10. One end of the elastic member 50 is abutted against the rotating shaft 40, and the other end of the elastic member 50 is abutted against the assembly protrusion 10a. The elastic member 50 is configured to provide a certain buffering effect between the camera body 10 and the first bracket 20. When the camera body 10 needs to rotate, the user can make the camera body 10 rotate relative to the first bracket 20 through manual operation. At this time, the rotating shaft 40 rotates in the rotation groove 20b, and the elastic member 50 plays a buffering and stabilizing role.

By setting the rotation groove 20b and the notch 20c at one end of the first bracket 20 away from the first quick-release structure 21, the camera body 10 can rotate relative to the first bracket 20. Compared with the related art, this design enables the camera body 10 to better adapt to the shooting requirements of different angles and positions during shooting, thereby improving the shooting efficiency and flexibility.

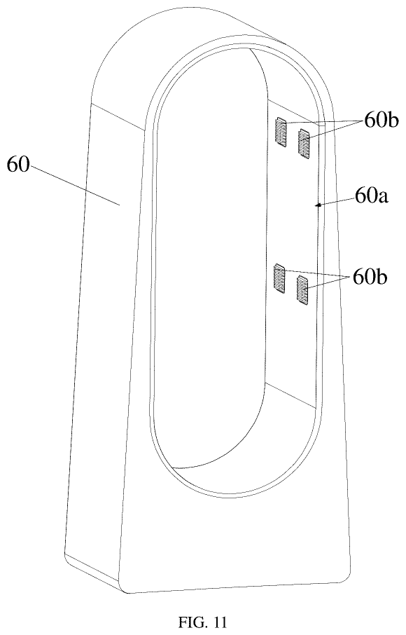

In an embodiment, as shown in FIG. 2, FIG. 3 and FIG. 11, the pet smart camera also includes a placement rack 60, and the placement rack 60 is provided with a fixed groove 60a; the groove wall of the fixed groove 60a is provided with a plurality of elastic plugs 60b, and the plurality of elastic plugs 60b are provided in an array. The camera body 10 is provided at the fixed groove 60a and elastically abutted against the plurality of elastic plugs 60b. And/or, the placement rack 60 is arched. And/or, the shape of the fixed groove 60a is adapted to the contour shape of the camera body 10.

The upper part of the placement rack 60 is provided with a fixed groove 60a, and the fixed groove 60a is configured to accommodate the camera body 10. The shape of the fixed groove 60a matches the bottom of the camera body 10 to ensure that the camera body 10 can be stably placed therein. The groove wall of the fixed groove 60a is provided with a plurality of elastic plugs 60b, and the plurality of elastic plugs 60b are provided in an array. The elastic plug 60b is made of soft rubber material and has good elasticity and wear resistance. The elastic plug 60b is configured to closely contact with the bottom of the camera body 10 when the camera body 10 is placed in the fixed groove 60a, so as to fix the camera body 10 in the fixed groove 60a.

The specific operation steps are as follows: aligning the bottom of the camera body 10 with the fixed groove 60a and slowly putting it in. When the bottom of the camera body 10 contacts the plurality of elastic plug 60b, the plurality of elastic plug 60b are squeezed and generate elastic force. The plurality of elastic plug 60b are tightly abutted against the bottom of the camera body 10, so that the camera body 10 is stably placed on the placement rack 60.

The design of the fixed groove 60a allows the camera body 10 to be firmly placed therein, avoiding the risk of the camera slipping or being damaged due to external forces. This is particularly important for pets that are active and lively in a home environment, and effectively improves the safety of use.

The design of the plurality of elastic plugs 60b on the inner groove wall of the fixed groove 60a provides a more delicate and stable fixing effect for the camera. The array arrangement of the plurality of elastic plugs 60b forms a uniform elastic abutment between the camera body 10 and the elastic plugs 60b. This design not only ensures the stability of the camera in the fixed groove 60a, but also allows the camera to have a certain buffer space when it is subjected to slight external forces, thereby avoiding damage to the camera caused by collision or vibration.

The camera body 10 can be fixed to the fixed groove 60a of the placement rack 60, so that the camera body 10 can be fixed to the wall by the wall-mounting bracket 30 and can also be fixed to any horizontal position by the placement rack 60, further broadening the use of pet smart cameras.

The arched structure can evenly disperse the pressure, so that the placement rack 60 can effectively resist the action of external forces when carrying heavy objects, and reduce the risk of structural damage caused by concentrated force. Compared with the traditional linear placement rack 60, the arched structure placement rack 60 has higher stability and load-bearing capacity under the same material and the same load-bearing conditions, which greatly improves the service life and safety of the placement rack 60. Due to its unique structural design, the arched placement rack 60 can provide a larger placement area in a limited space, which is particularly beneficial for places with limited space.

The body of the fixed groove 60a is made of high-strength engineering plastics, which has good wear resistance and impact resistance. The fixed groove 60a body is in the shape of a long strip, and its cross-sectional shape matches the contour shape of the camera body 10, ensuring that the fixed groove 60a and the camera body 10 are closely fitted. A plurality of protrusions are provided inside the fixed groove 60a, and these protrusions correspond to the contour shape of the camera body 10 and play a fixing role.

This design not only makes the camera more stable in the fixed groove 60a, avoiding damage caused by shaking or displacement, but also improves the protection performance of the camera in complex environments, and effectively reduces the risk of damage that may occur to the camera during use.

Due to the adaptability of the fixed groove 60a to the contour shape of the camera body 10, the installation and removal process of the camera in the fixed groove 60a is more convenient. Users only need to gently put in or take out the camera, which greatly saves installation and removal time and improves usage efficiency.

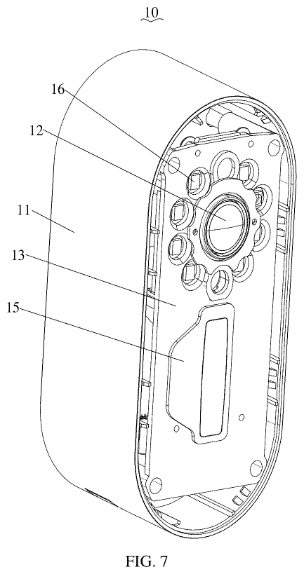

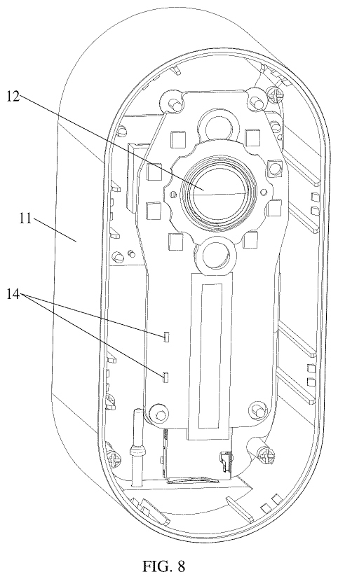

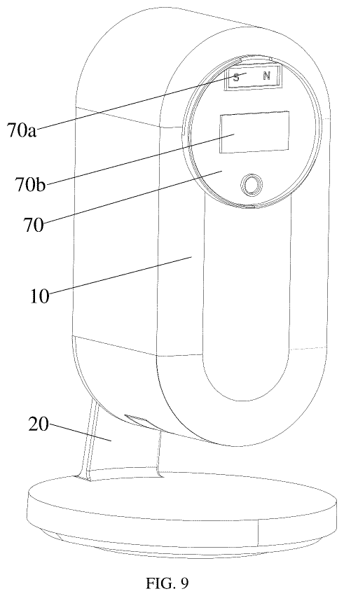

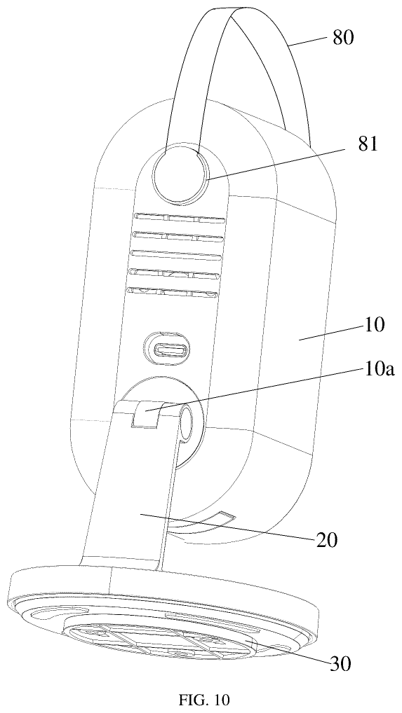

In an embodiment, as shown in FIG. 2, FIG. 7, FIG. 8, FIG. 9 and FIG. 10, the camera body 10 includes a housing 11 and a lens 12 installed at the housing 11. The housing 11 includes an assembly port, and the lens 12 is provided at the assembly port. The housing 11 also includes at least one first magnetic member, and the first magnetic member is staggered with the lens 12. The pet smart camera also includes a cover 70, the cover 70 is provided with at least one second magnetic member 70a, and the second magnetic member 70a is attracted and combined with the first magnetic member, enabling the cover 70 to be closed on the assembly port and block the lens 12. And/or, the cover 70 is also provided with a third magnetic member 70b, and the third magnetic member 70b is provided at the center of the cover 70 and is spaced apart from the second magnetic member 70a. The third magnetic member 70b is attracted and combined with the first magnetic member, enabling the cover 70 to be staggered with the assembly port.

The housing 11 is made of high-strength wear-resistant material and has excellent protective performance. The housing 11 is provided with an assembly port for installing the lens 12. The lens 12 is provided at the assembly port and has a high-definition shooting function, which can capture every detail of the pet's activities. The first magnetic member is provided inside the housing 11 and is staggered with the lens 12. The magnetic member is made of high-performance magnetic material and can provide sufficient magnetic attraction. The cover 70 is provided with at least one second magnetic member 70a, which corresponds to the first magnetic member and can be attracted to the first magnetic member. The cover 70 is detachable, so that the user can open or close it when needed.

The present application introduces the cover 70 and the second magnetic member 70a thereon, and the second magnetic member 70a is attracted and combined with the first magnetic member in the housing 11, so that the cover 70 can easily cover the assembly port and block the lens 12. This design not only protects the user's privacy, but also avoids dust and scratches on the lens 12 when not in use.

By adding the third magnetic member 70b, not only the overall structure of the cover 70 is optimized, but also the magnetic connection between the cover 70 and the assembly port is enhanced, so that the cover 70 can be more stable during the assembly process and when the camera body 10 is in normal use, and is not easy to fall off from the camera body 10, thereby improving the reliability and durability of the product.

In an embodiment, as shown in FIG. 2, FIG. 7, FIG. 8, FIG. 9 and FIG. 10, the camera body 10 also includes a main circuit board 13, at least two function indicator lights 14 and at least one light guide column 15. The main circuit board 13 is provided in the housing 11. The lens 12 and the at least two function indicator lights 14 are provided at the main circuit board 13 and are electrically connected to the main circuit board 13. The light guide column 15 is provided in front of the at least two function indicator lights 14 and is configured to transmit the light of the at least two function indicator lights 14 to the outside world. And/or, the camera body 10 also includes a plurality of night vision infrared lights 16. The plurality of night vision infrared lights 16 are provided at the main circuit board 13 and are electrically connected to the main circuit board 13, and the plurality of night vision infrared lights 16 are provided around the lens 12.

The housing 11 is made of high-strength wear-resistant material, has good protective performance, and can effectively protect the internal components from the influence of the external environment. The main circuit board 13 is provided inside the housing 11 and is the core component of the camera body 10. The multi-layer circuit layout design is adopted for the main circuit board 13, which significantly improves the stability and anti-interference ability of the signal. The lens 12 is provided at the main circuit board 13 and is tightly connected to the main circuit board 13 through a precise fixing device. Two function indicator lights 14 are provided at the main circuit board 13 and are electrically connected to the main circuit board 13. The function indicator light 14 adopts LED light-emitting devices, which have the characteristics of low power consumption and high brightness. The function indicator light 14 can display different working states, such as shooting, recording, charging, etc.

The light guide column 15 is provided in front of the at least two function indicator lights 14, and is configured to transmit the light of the at least two function indicator lights 14 to the outside world. The light guide column 15 is made of transparent or translucent materials and has good light transmittance. The shape and size of the light guide column 15 are reasonably designed, which can effectively improve the light transmission efficiency.

When the camera is turned on, the main circuit board 13 starts to work, collects light signal through the lens 12 and converts the light signal into an electrical signal. The main circuit board 13 processes the electrical signal to generate image information. The function indicator light 14 displays the corresponding light signal according to the working state of the camera. The light guide column 15 transmits the light of the function indicator light 14 to the outside world for user observation.

The lens 12 and the at least two function indicator lights 14 are provided at the main circuit board 13 and are electrically connected to the main circuit board 13. This design simplifies the circuit connection and reduces the probability of failure. At the same time, the stability of the electrical connection ensures the efficiency and accuracy of signal transmission, thereby improving the overall performance of the camera.

The light guide column 15 is provided in front of the at least two function indicator lights 14, and is configured to transmit the light of the at least two function indicator lights 14 to the outside world. This design increases the visibility of the indicator lights. Even in a dark environment, the user can clearly observe the working status of the indicator lights, which improves the convenience of camera operation.

Eight night vision infrared lights 16 are provided around the lens 12 to form a ring array. This arrangement can ensure that the camera can still obtain clear images at night or in low light environments with the assistance of the night vision infrared lights 16.

When the camera is in a night or low light environment, the main circuit board 13 automatically detects the ambient light intensity. If the ambient light intensity is lower than the preset threshold, the night vision infrared light 16 is activated. The infrared light emitted by the night vision infrared light 16 irradiates the photographed object, and reflects back to the lens 12. Then the infrared light reflected back to the lens 12 is processed by the main circuit board 13, and finally a clear image is achieved.

The present application effectively improves the camera's shooting capability in low-light environments by providing multiple night vision infrared lights 16 on the main circuit board 13. Compared with the related art, this design enables the camera body 10 to capture clearer and more detailed images at night or in low-light conditions, greatly broadening the application scenarios of the camera.

In addition, as shown in FIG. 10, the pet smart camera further includes a hanging rope 80, which can be used by the user to carry the pet smart camera. The pet smart camera is provided with a plug hole 81 on the side away from the third magnetic member, one end of the hanging rope is connected to the third magnetic member by magnetic attraction, and the other end of the hanging rope is clamped in the plug hole 81.

The above contents are only some embodiments of the present application, and do not limit the scope of the present application. All equivalent structural changes made by using the contents of the present application specification and drawings under the inventive concept of the present application, or directly/indirectly applied in other related technical fields are included in the scope of the present application.

What is claimed is:

1. A pet smart camera, comprising:
a camera body;
a first bracket; and
a wall-mounting bracket;
wherein the first bracket is rotatably connected to the camera body, and a first quick-release structure is provided at one end of the first bracket away from the camera body; and
the wall-mounting bracket is fixed on a wall; a second quick-release structure is provided on a side of the wall-mounting bracket facing away from the wall, and the first quick-release structure is connected to the second quick-release structure to fix the camera body and the first bracket on the wall.

2. The pet smart camera of claim 1, wherein the first quick-release structure comprises at least two clamping positions, and the at least two clamping positions are spaced apart; the second quick-release structure comprises at least two clamping protrusions, and the at least two clamping protrusions are spaced apart; each clamping protrusion is clamped into one of the clamping positions, and the wall-mounting bracket is detachably connected with the first bracket.

3. The pet smart camera of claim 2, wherein each of the clamping protrusions is provided with an embedding hole; a side of the first bracket facing the wall-mounting bracket is provided with a counterbore, a guide hole and a retaining rib opposite to a bottom wall of the counterbore; the counterbore is communicated with the guide hole to form the clamping position; the clamping protrusion is configured to slide into the counterbore along the guide hole, enabling the retaining rib to be clamped into the embedding hole.

4. The pet smart camera of claim 3, wherein a limiting convex point is provided on a side of the clamping protrusion facing the first bracket; a limiting groove is provided at the bottom wall of the counterbore, and when the limiting convex point is clamped into the limiting groove, the retaining rib is clamped into the embedding hole.

5. The pet smart camera of claim 1, wherein the first bracket comprises a frame, a base, a fixed block, and at least one connecting member; one end of the frame is rotatably connected to the camera body, and the other end of the frame is rotatably connected to the base; the base is provided with a mounting hole and the first quick-release structure, and the mounting hole is configured to pass through the base and is spaced apart from the first quick-release structure; the fixed block is provided on a side of the base facing away from the frame; the connecting member is configured to pass through the fixed block and the mounting hole, and the connecting member is connected to the frame; and/or
the base is further provided with a turntable, and the turntable is provided with a mounting groove; the mounting groove is communicated with the mounting hole and is coaxially with the mounting hole; the mounting groove is provided at the side of the base facing away from the frame, and the fixed block is provided in the mounting groove.

6. The pet smart camera of claim 5, wherein an annular groove is provided on one side of the frame facing the turntable; the first bracket further comprises an elastic ring, and the elastic ring is provided in the annular groove and elastically abutted against the turntable.

7. The pet smart camera of claim 1, further comprising:
a rotating shaft; and
an elastic member;
wherein an end of the first bracket away from the first quick-release structure is provided with a rotation groove and a notch communicated with the rotation groove; an outer wall of the camera body is provided with an assembly protrusion, and the assembly protrusion is provided at the notch; the rotating shaft is inserted into the rotation groove and is configured to pass through the assembly protrusion; one end of the elastic member is abutted against the rotating shaft, and the other end of the elastic member is abutted against the assembly protrusion, enabling the camera body to rotate relative to the first bracket.

8. The pet smart camera of claim 1, further comprising:
a placement rack;
wherein the placement rack is provided with a fixed groove; a groove wall of the fixed groove is provided with a plurality of elastic plugs, and the plurality of elastic plugs are provided in an array; the camera body is provided at the fixed groove and elastically abutted against the plurality of elastic plugs; and/or
the placement rack is arched; and/or
a shape of the fixed groove is adapted to a contour shape of the camera body.

9. The pet smart camera of claim 1, further comprising:
a cover;
wherein the camera body comprises a housing and a lens provided in the housing; the housing comprises an assembly port, and the lens is provided at the assembly port; at least one first magnetic member is provided in the housing, and the first magnetic member is staggered with the lens;
the cover is provided with at least one second magnetic member, and the second magnetic member is attracted and combined with the first magnetic member, enabling the cover to be covered on the assembly port and to block the lens; and/or
the cover is further provided with a third magnetic member, and the third magnetic member is provided at a center of the cover, and is spaced apart from the second magnetic member; and the third magnetic member is attracted and combined with the first magnetic member, enabling the cover to be staggered with the assembly port.

10. The pet smart camera of claim 9, wherein the camera body further comprises a main circuit board, at least two function indicator lights and at least one light guide column; the main circuit board is provided in the housing; the lens and the at least two function indicator lights are provided at the main circuit board and are electrically connected to the main circuit board; the light guide column is provided in front of the at least two function indicator lights and is configured to transmit the light of the at least two function indicator lights to an outside world; and/or
the camera body further comprises a plurality of night vision infrared lights; the plurality of night vision infrared lights are provided at the main circuit board and are electrically connected to the main circuit board, and the plurality of night vision infrared lights are provided around the lens.
